(19) United States
(12) Patent Application Publication
(10) Pub. No.: US 2017/0370798 A1
(43) Pub. Date: Dec. 28, 2017

(54) LARGE SPACE STRUCTURE COLLAPSE DETECTION APPARATUS AND COLLAPSE DETECTION METHOD USING THE SAME

(71) Applicants: Globiz Co., Ltd., Seoul (KR); MIDAS IT Information Technology Co., Ltd., Gyeonggi-do (KR)

(72) Inventors: Junsik IM, Seoul (KR); Seon Gyu KIM, Seoul (KR); Sun Young CHOI, Yongin-si (KR)

(21) Appl. No.: 15/527,016

(22) PCT Filed: Aug. 18, 2016
(86) PCT No.: PCT/KR2016/009099

§ 371 Date: May 16, 2017

(30) Foreign Application Priority Data
Aug. 31, 2015 (KR) 10-2015-0123170
Feb. 2, 2016 (KR) 10-2016-0012948

(51) Int. Cl. G01M 5/00; G01L 1/10; G01L 5/00; G08B 21/02

(52) U.S. Cl. CPC G01M 5/0066; G01L 5/00; G01L 1/10; G08B 21/02

(57) ABSTRACT

A method for a large space structure collapse detection apparatus to detect collapse of a large space structure according to the present invention includes: measuring a change in external load with respect to at least one main member in the large structure; calculating a stress or stress sensitivity according to the measured change in the external load; and comparing at least one of the calculated stress or the calculated stress sensitivity with a predetermined collapse diagnosis reference value and determining a risk of collapse of the large space structure.

### TECHNICAL FIELD

A first exemplary embodiment of the present invention relates to an apparatus for detecting collapse of a large space structure and a method for detecting collapse using the same, and a second exemplary embodiment of the present invention relates to an apparatus for monitoring a structure using the same.

### BACKGROUND ART

In general, a large space structure includes a structure that has an internal space like a general building, and also includes various special types of structures such as a gymnasium, a factory structure, or a golf driving range. In addition, such a large space structure has been used in real life with various forms for various purposes.

However, a specific type of large space structure like a multiuse facility and a factory building has few intermediate columns and thus the structure is very weak to natural disasters as well as aging. Accordingly, a method for scientifically detect a risk of collapse of the structure needs to be researched and developed. In particular, collapse of the large space structure causes damage to people and economic loss.

Accordingly, a method for predict a risk of collapse due to a natural disaster such as heavy snow, typhoons, earthquakes, and the like at an early stage, and notifying the risk of collapse, has been required.

In addition, recently, a large structure or a high-rise building has been adopting a structural health monitoring system to determine whether or not to continuously use the structure or the building by monitoring structural safety when an unexpected disaster, such as a natural disaster, a fire, explosion, or collision by a plane, occurs.

Further, in many countries, it has been prescribed by law to monitor structural health in real time for buildings over a predetermined size. To this end, various types of sensors are embedded/installed in the structure, and the structural health monitoring system determines structural health of the structure by analyzing values measured by the sensors. Here, the most commonly used sensor for monitoring structural health of many buildings is a vibrating wire type of strain sensor because it is relatively inexpensive and has almost infinite durability.

However, a conventional structural health monitoring system sequentially reads values measured through sensors, and thus there is a limit in analysis of a strain aspect in a high-rise building that finely vibrates with a natural low frequency.

The above information disclosed in this Background section is only for enhancement of understanding of the background of the invention and therefore it may contain information that does not form the prior art that is already known in this country to a person of ordinary skill in the art.

### DISCLOSURE

### Technical Problem

A first exemplary embodiment of the present invention has been made in an effort to provide a large space structure collapse detection apparatus that can detect a collapse risk of a large space structure early, and a collapse detection method using the same.

### Technical Solution

A second exemplary embodiment of the present invention provides a structure monitoring apparatus that can monitor structural health of a structure by detection strain of a dynamic behavior of the structure according to an external load, and a structure monitoring method using the same.

A method for a large space structure collapse detection apparatus to detect collapse of a large space structure according to a first exemplary embodiment of the present invention includes: measuring a change in external load with respect to at least one main member in the large structure; calculating a stress or stress sensitivity according to the measured change in the external load; and comparing at least one of the calculated stress or the calculated stress sensitivity with a predetermined collapse diagnosis reference value and determining a risk of collapse of the large space structure.

The determination of the risk of collapse may include determining that there is a risk of collapse of the large space structure when the stress or the stress sensitivity exceeds the collapse diagnosis reference value by a certain number of times or by a predetermined time period.

The method for the large space structure collapse detection apparatus to detect collapse of the large space structure may further include: storing the measured external load change and a result of the comparison between the stress or the stress sensitivity and the collapse diagnosis reference value; and notifying the collapse risk to an external server when it is determined that the structure has a risk of collapse.

The external load may include at least one of a snow load, a wind load, and an earthquake load.

The stress sensitivity may include stress strain in the main member according to a change in the snow load, the wind load, or the earthquake load.

The at least one main member may include a maximum occurrence location of the stress or the stress sensitivity with respect to the external load.

The maximum occurrence location of the stress or stress sensitivity may include at least one of an upper end point of a roof material of the large space structure, a side point of the roof member, and a lower end point of a column member of the large space structure.

A large space structure collapse detection apparatus according to another example of the first exemplary embodiment of the present invention includes: a measurement unit that measures a change in external load with respect to at least one main member of a large space structure; and a control unit that calculates stress or stress sensitivity according to the measured external load change, and determines a risk of collapse of the large space structure by comparing at least one of the stress or the stress sensitivity with a predetermined collapse diagnosis reference value.

The measurement unit may measure the external load change from sensors that are disposed in maximum occurrence locations of the stress or the stress sensitivity with respect to the external load.

The maximum stress or maximum stress sensitivity occurrence locations may include a location having the highest stress or stress strain in the main member according to a change in one of external loads of a snow load, a wind load, and an earthquake load.

The control unit may include: a sensitivity calculation unit that calculates stress and stress sensitivity according to the measured external load change; and a collapse risk determination unit that determines a collapse risk of the large space structure by comparing the calculated stress and the calculated stress sensitivity with a predetermined collapse diagnosis reference value.

The sensitivity calculation unit may calculate stress strain of the main member according to a change in the snow load, the wind load, or the earthquake load at the maximum stress occurrence location or the maximum stress sensitivity occurrence location.

The large space structure collapse detection apparatus may further include: a database that stores the measured external load change and a result of comparison between the stress and stress sensitivity and the collapse diagnosis reference value; and a collapse risk notification unit that notifies a collapse risk to an external server when it is determined that the large space structure has a collapse risk.

A method for a structure monitoring apparatus to monitor safety of a structure by measuring vibration of the structure according to a second exemplary embodiment of the present invention includes: setting measurement cycles of a plurality of sensors disposed in the structure; simultaneously measuring a change in external load of the structure using at least two of the plurality of sensors according to the predetermined measurement cycles; and calculating strain of the structure by simultaneously analyzing measured signals and forming a time-based strain variation chart.

The forming of the strain variation chart may include deducting maximum and minimum strain values by curve-fitting time-based strain values to a sine wave.

The method for the structure monitoring apparatus to monitor safety of the structure by measuring vibration of the structure may further include calculating a stress with respect to a main member of the structure by using the maximum and minimum strain values, and determining safety of the structure by using the calculated stress.

The setting of the measurement cycle may include synchronization of measurements of the plurality of sensors.

The plurality of sensors may include vibrating wire sensors.

The measuring may include exciting the vibrating wire sensors while changing measurement frequencies of the vibrating wire sensors and measuring vibration signals of the vibrating wire sensor, and the forming of the strain variation chart may include: calculating resonance frequencies of the vibrating wire sensors by analyzing the measured vibration signals; and calculating strain values in the resonance frequencies.

The measuring may further include simultaneous measuring of temperatures of the vibrating wire sensors together with the vibration signals of the vibrating wire sensors, and the deducting of the strain may further include compensating the calculated strain by using variation of the measured temperature.

A structure monitoring apparatus according to another example of the second exemplary embodiment of the present invention includes: a measurement unit that applies signals to a plurality of sensors disposed in a structure and measures vibration or temperatures through the plurality of sensors; and a control unit that sets measurement cycles of the plurality of sensors, deducts strain of the structure by using the vibration or temperature measured through the sensors, and determines safety of the structure based on the deducted strain.

The control unit may include a synchronization unit that synchronizes the measurement cycles of the plurality of sensors.

The synchronization unit may control the plurality of sensors to simultaneously measure a change in external load of the structure.

The control unit may include: a strain deduction unit that deducts the strain of the structure by using the vibration measured through the plurality of sensors; and a compensation unit that compensates the strain by using the measured temperature change.

The strain deduction unit may calculate a maximum strain value and a minimum strain value by curve-fitting time-based strain variation to a sine wave of a primary strain mode with respect to the structure, and the primary strain mode may include strain in a low frequency area among strains of the structure.

The structure monitoring apparatus may further include a safety determination unit that calculates a stress with respect to a main member of the structure by using the maximum strain value and the minimum strain value, and determines safety of the structure by using the calculated stress.

The plurality of sensors may include vibrating wire sensors.

The vibrating wire sensors may be disposed in locations where maximum stress sensitivity with respect to the external load occurs.

The maximum stress sensitivity occurrence locations may include a location having the highest stress strain in the main member according to a change in at least one of external loads of a snow load, a wind load, and an earthquake load.

### Advantageous Effects

According to the first exemplary embodiment of the present invention, stress and stress sensitivity of a main member according to an external load change at a location having the highest stress strain with respect to an external load applied to a large space structure are analyzed to determine a collapse risk of the large space structure, and the collapse risk is notified to a user and a manager to thereby provide early prediction of a collapse risk and prevent damage due to the collapse risk in advance.

In addition, according to the second exemplary embodiment of the present invention, an environment where measurements of multi-channel vibrating wire channels are synchronized to estimate maximum and minimum working strain generated due to a low-frequency dynamic behavior of the structure or measure maximum and minimum working strain by adjusting sampling time for vibration measurement to thereby shorten measurement time in a large-scaled structure or a high-rise building and accurately monitor structural health can be provided.

Further, according to the second exemplary embodiment of the present invention, vibrating wire sensors are installed at locations where maximum stress sensitivity with respect to an external load is generated in a structure such as a building, a measurement start point and a measurement cycle are automatically optimized, and measurement synchronization of the vibrating wire sensors and curve-fitting with respect to the primary strain mode of the low frequency are performed such that an environment where maximum strain occurrence time in time-based strain variation with respect to an external load applied to the building and the structure and strain at the time can be accurately measured and structural health can be more accurately monitored can be provided.

### DESCRIPTION OF THE DRAWINGS

FIG. 1 schematically illustrates a structure of a large space structure collapse detection apparatus according to a first exemplary embodiment of the present invention.

FIG. 2 is a flowchart of a process for the large space structure collapse detection apparatus according to the first exemplary embodiment of the present invention to detect a collapse risk.

FIG. 3 illustrates an example of an external load applied to the large space structure.

FIG. 4 illustrates a result of stress sensitivity analysis with respect to a roof member, acquired by using a finite element method according to the first exemplary embodiment of the present invention.

FIG. 5 illustrates a result of stress sensitivity analysis with respect to a column member, acquired by using a finite element method according to the first exemplary embodiment of the present invention.

FIG. 6 shows locations where maximum stress or maximum stress sensitivity occurs in the large space structure according to the first exemplary embodiment of the present invention.

FIG. 7 schematically illustrates a structure of a structure monitoring apparatus according to a second exemplary embodiment of the present invention.

FIG. 8 is a schematic flowchart of a process for monitoring a structure by synchronizing measurement cycles of vibrating wire sensors according to the second exemplary embodiment of the present invention.

FIG. 9 exemplarily illustrates a layout of a plurality of vibrating wire sensors in a large-scaled structure.

FIG. 10 is a graph that exemplarily shows sequential measurement of signals of the sensors according to a conventional art.

FIG. 11 is a graph that exemplarily shows a low-frequency variation chart according to the second exemplary embodiment of the present invention.

FIG. 12 is a graph that exemplarily shows deduction of maximum and minimum values by forming a low-frequency variation chart for each sensor according to the second exemplary embodiment of the present invention.

FIG. 13 shows a process for monitoring a structure according to the second exemplary embodiment of the present invention.

### MODE FOR INVENTION

The present invention will be described more fully hereinafter with reference to the accompanying drawings, in which exemplary embodiments of the invention are shown. The present invention should not be construed as limited to the exemplary embodiments set forth herein, and may be modified in various different ways.

Throughout the specification, unless explicitly described to the contrary, the word “comprise” and variations such as “comprises” or “comprising” will be understood to imply the inclusion of stated elements but not the exclusion of any other elements.

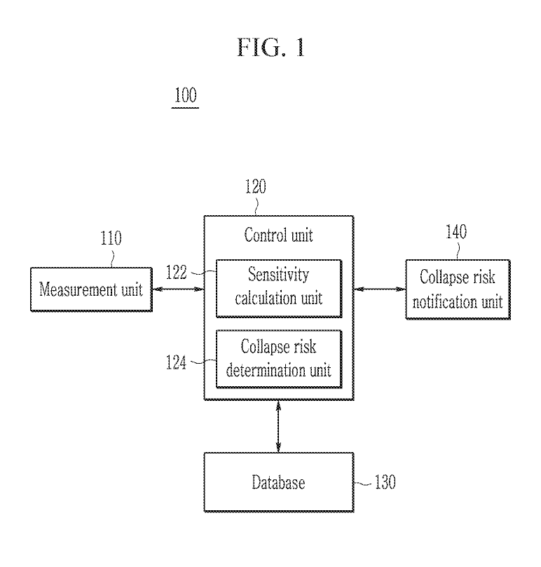

FIG. 1 schematically illustrates a structure of a large space structure collapse detection apparatus according to a first exemplary embodiment of the present invention. A configuration of the large space structure collapse detection apparatus shown in FIG. 1 is schematically illustrated for description, and thus it is not restrictive.

A large space structure collapse detection apparatus 100 according to the first exemplary embodiment of the present invention is an apparatus that performs early diagnosis of a collapse risk due to a change in an external load condition of a large space structure and notifies the collapse risk to a manager and a user. Here, the large space structure includes a building having an internal space, and also includes structures with few or no beams or columns for wide utilization of the internal space, such as multi-use facilities used as an auditorium or a gymnasium as well as factory buildings.

Referring to FIG. 1, the large space structure collapse detection apparatus 100 according to the first exemplary embodiment of the present invention includes a measurement unit 110, a control unit 120, a database 130, and a collapse risk notification unit 140.

The measurement unit 110 measures a change in an external load with respect to at least one primary member of a large space structure. The measurement unit 110 measures the change of the external load through a sensor that is disposed at a location where a stress or maximum sensitivity of stress with respect to an external load or maximum sensitivity of the stress is generated.

The control unit 120 calculates the measured stress and the measured stress sensitivity according to the change of the external load, and controls to determine a collapse risk of the large space structure by comparing the calculated stress sensitivity and a predetermined collapse diagnosis reference value.

Here, the external load includes at least one of a snow load, a wind load, or an earthquake load. The stress sensitivity includes a stress change rate in the main member according to a change in the snow load, the wind load, or the earthquake load. In addition, the location where the stress or the maximum stress sensitivity is generated may include at least one of an upper end point of a roof material of the large space structure, a side point of the roof member, and a lower end point of a column member of the large space structure.

The control unit 120 converts the measurement signal measured by the measurement unit 110 into a digital signal to calculate whether or not collapse diagnosis criteria that have been analytically selected in advance are satisfied, to thereby finally determine a collapse risk with consideration of repeatability and durability.

To this end, the control unit 120 may be implemented as one or more processes operated by a predetermined program, and the predetermined program may be programed to perform each stage of a collapse detection method according to an exemplary embodiment of the present invention.

The control unit 120 includes a sensitivity calculation unit 122 and a collapse risk determiner 124 according to the first exemplary embodiment of the present invention.

The sensitivity calculation unit 122 calculates a stress and stress sensitivity according to the measured change in the external load.

In addition, the collapse risk determiner 124 compares the calculated stress and stress sensitivity with the predetermined collapse diagnosis reference value, and determines a collapse risk of the large space structure. In this case, the collapse risk determiner 124 may determine that the large space structure has a collapse risk when the stress sensitivity exceeds the collapse diagnosis reference value by a certain number of times or by a predetermined time period.

The database 130 stores the measured change in the external load, the measured stress, the measured stress sensitivity, and the result of the comparison with the collapse diagnosis reference value.

The collapse risk notification unit 140 notifies the collapse risk to an external server if it is determined that there is a risk of collapse of the large space structure. The collapse risk notification unit 140 automatically transmits a signal to a mobile user who has registered in advance through an application to receive notification of a collapse risk or mobile users at the periphery of the structure through connection with a mobile communication company, and guides the users to a safe place.

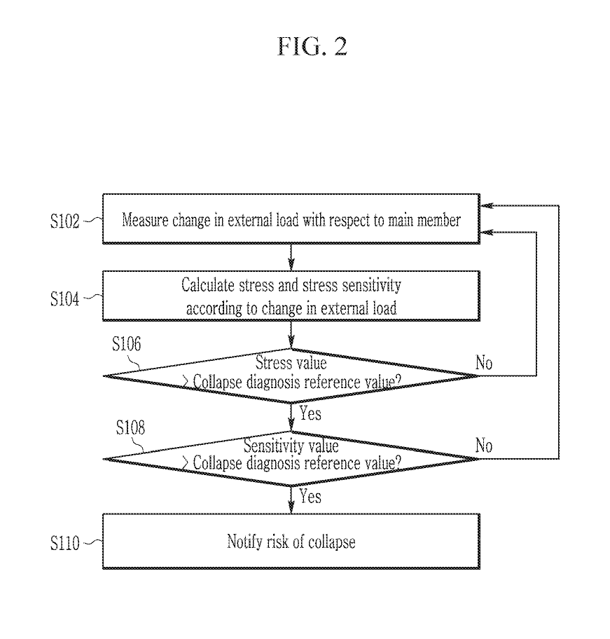

FIG. 2 is a flowchart of a process for the large space structure collapse detection apparatus according to the first exemplary embodiment of the present invention to detect a collapse risk. The following flowchart will be described using the same reference numerals of FIG. 1.

Referring to FIG. 2, the large space collapse detection apparatus 100 according to the first exemplary embodiment of the present invention measures a change in an external load with respect to a main member of a large space structure (S102).

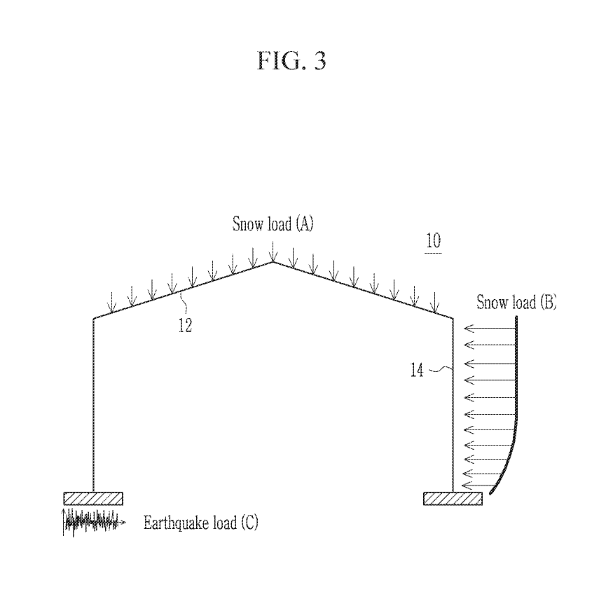

FIG. 3 shows examples of the external load applied to the large space structure.

A large space structure 10 includes a roof member 12 and a column member 14, and an external load, which is a typical load, is considered in the design of the large space structure 10. In addition, the external load applied to the large space structure 10 includes a snow load A, a wind load B, and an earthquake load C.

As shown in FIG. 3, the roof member 12 of the large space structure 10 is greatly influenced by the snow load A, and the column member 14 is greatly influenced by the wind load B or the earthquake load C.

Here, when a stress applied to the members due to natural environmental causes, such as a snow load, a wind load, and an earthquake load exceeds a yield criterion, a collapse may occur, and therefore the large space structure collapse detection apparatus 100 according to the first exemplary embodiment of the present invention very effectively enables early diagnosis of a collapse risk using minimum sensors by attaching a strain sensor not to a location where maximum strain of a member occurs at present due to a typical load based on design, but to a location where a maximum stress or maximum stress sensitivity occurs.

In addition, the large space structure collapse detection apparatus 10 calculates a stress and stress sensitivity according to an external load change at the location where the maximum stress or the maximum stress sensitivity occurs (S104). Here, the stress sensitivity includes a stress change rate of the main member according to a change in the snow load, the wind load, or the earthquake load.

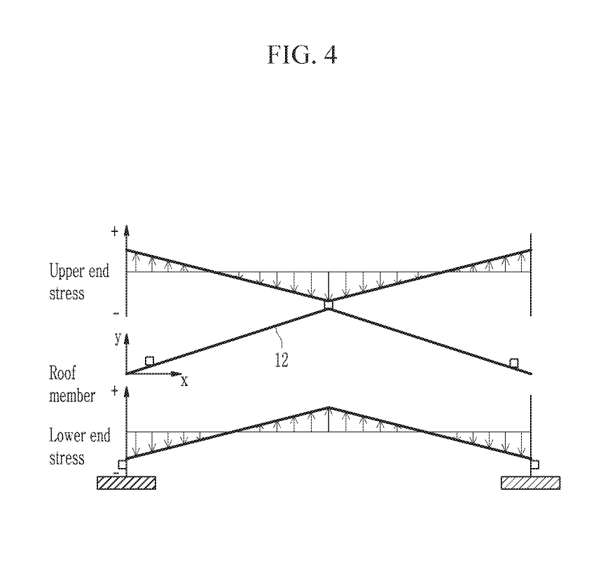

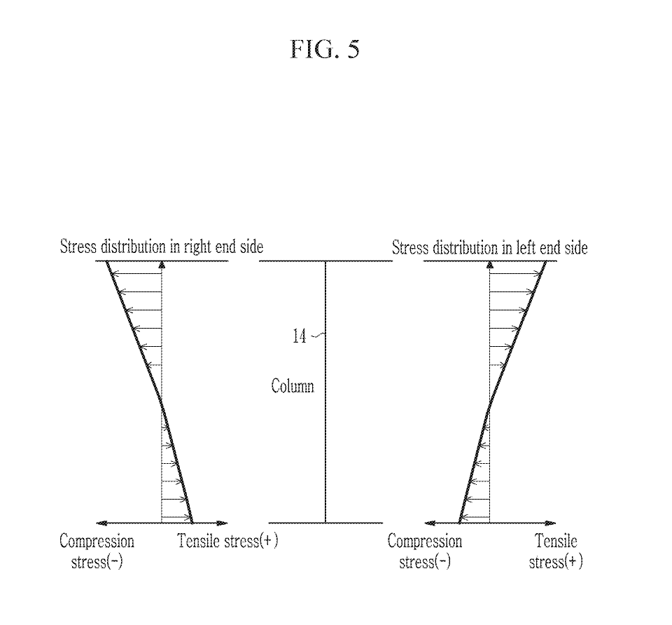

FIG. 4 shows a result of analysis of stress and stress sensitivity with respect to the roof member using a finite element method according to the first exemplary embodiment of the present invention, and FIG. 5 shows a result of analysis of stress sensitivity with respect to the column member using the finite element method according to the first exemplary embodiment of the present invention.

The large space structure collapse detection apparatus 100 according to the first exemplary embodiment of the present invention uses sensors attached to locations where stress sensitivity of the main member with respect to a change in the external load criterion is high. In general, a stress a of the roof member and the column member, which are main members of the large space structure, can be acquired as given in Equation 1.

σ=f(A,L,I,E,p) (Equation 1)

Here, A denotes a cross-section of the main member and L denotes a length of the main member. In addition, I denotes an inertia moment, E denotes an elastic coefficient of the main member, and p denotes a working pressure applied to the main member.

The stress sensitivity can be represented as a partial differential with respect to the external load, and can be calculated as given in Equation 2. The stress sensitivity can be deducted through a finite-element method, or can be formally induced using a sensitivity analysis method.

∂σ/∂p=f(A,L,I,E,p+Δp)−f(A,L,I,E,p)/Δp (Equation 2)

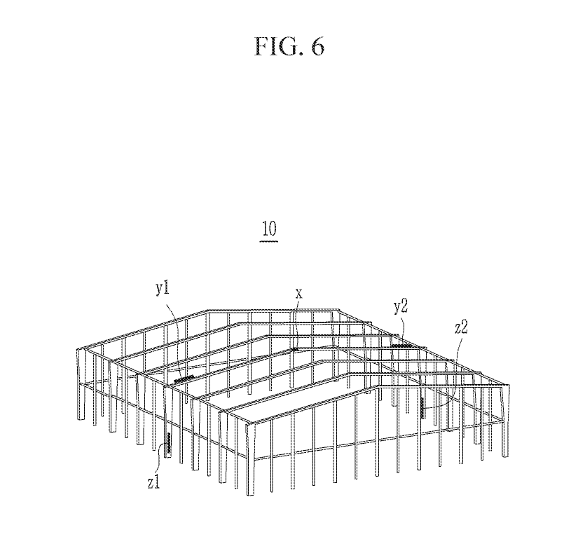

FIG. 6 shows locations where the maximum stress or the maximum stress sensitivity occurs in the large space structure according to the first exemplary embodiment of the present invention. FIG. 6 shows an example of an optimal attachment of the sensor by the sensitivity analysis method according to the first exemplary embodiment of the present invention.

As shown in FIG. 6, the large space structure collapse detection apparatus 100 according to the first exemplary embodiment of the present invention can measure the external load change by attaching the sensor in the locations where the maximum stress or the maximum stress sensitivity with respect to the external load occur, that is, an upper end point x of the roof member 12, side points y1 and y2 of the roof member 12, and lower end points z1 and z2 of the column member 14.

In addition, the large space structure collapse detection apparatus 100 according to the first exemplary embodiment of the present invention determines a collapse risk of the large space structure by comparing the stress or stress sensitivity with a predetermined collapse diagnosis reference value (S106 and S108). The large space structure collapse detection apparatus 100 determines that the large space structure has a risk of collapse when the stress or stress sensitivity is greater than the collapse diagnosis reference value.

Here, in the first exemplary embodiment of the present invention, a stress value is compared with a collapse diagnosis reference value and then a sensitivity value is compared with the collapse diagnosis reference value, but this is not restrictive. A risk of collapse may be determined by comparing only one of stress and stress sensitivity, and determination of the risk of collapse can be variously modified depending on a collapse diagnosis environment of the large space structure.

In addition, when the stress or stress sensitivity exceeds the collapse diagnosis reference value by a predetermined number of times or over a predetermined time period, the large space structure collapse risk 100 may determine a risk of collapse of the large space structure.

In addition, the large space structure collapse detection apparatus 100 stores the measured change of external load, the measured stress, and the result of comparison between the stress sensitivity and the collapse diagnosis reference value, and notifies the risk of collapse to the external server if it is determined that there is a risk of collapse of the large space structure (S110).

In this case, facility managers, employees, and users of the corresponding large space structure register their mobile phones and e-mail recipient addresses to a data base of the large space structure collapse detection apparatus 100, and the large space structure collapse detection apparatus 100 automatically notifies a warning or alert of collapse when a high risk occurs. In addition, the large space structure collapse detection apparatus 100 pre-registers location information of the corresponding large space structure to a telecommunication agency, and notifies a danger of collapse to mobile users at the periphery of the place where the warning or alert of collapse has taken place.

As described, the large space structure collapse detection apparatus 100 according to the first exemplary embodiment of the present invention provides an environment where stress and stress sensitivity of the main member with respect to an external load applied to the large space structure at a location having the highest stress or highest stress strain are analyzed to determine a collapse risk of the large space structure and automatically notify the collapse risk to the users and the manager, to thereby perform early prediction of a collapse risk and prevent damage in advance.

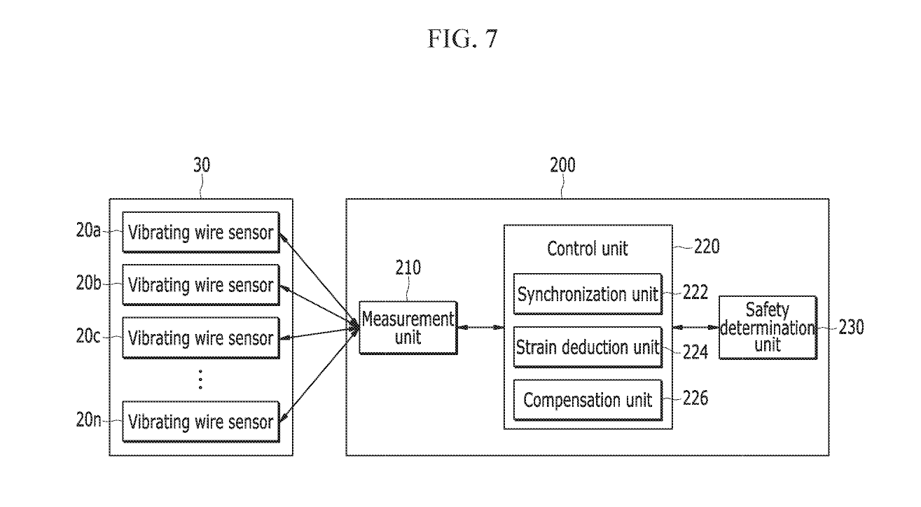

FIG. 7 schematically shows a structure of a structure monitoring apparatus according to a second exemplary embodiment of the present invention. Only schematic constituent elements of the structure monitoring apparatus are shown in the drawing for convenience of description, and the present invention is not limited thereto.

Referring to FIG. 7, a structure monitoring apparatus 200 according to the second exemplary embodiment of the present invention includes a measurement unit 210, a control unit 220, and a safety determination unit 230.

The measurement unit 210 applies a signal to a plurality of sensors 20a to 20n that are provided in a structure 30, and measures vibration or a temperature of the plurality of sensors 20a to 20n.

Here, the plurality of sensors 20a to 20n include a vibrating wire sensor, a vibrating wire type of strain sensor, or a temperature sensor, and they may be disposed at locations where maximum sensitivity of stress with respect to an external load is generated. In addition, the locations where the maximum sensitivity of stress is generated include a point of the maximum sensitivity of stress in a main member according to a change of an external load among a snow load, a wind load, or an earthquake load.

The control unit 220 sets a measurement cycle of the plurality of sensors 20a to 20n, and deducts a strain of the structure 30 in real time from the vibration or temperature measured through the plurality of sensors 20a to 20n.

In addition, the control unit 220 controls safety of the structure 30 to be determined by using the deducted strain.

To this end, the control unit 220 may be implemented as at least one of processors operating by a predetermined program, and the predetermined program may be programmed to perform each stage of a structure monitoring method according to an exemplary embodiment of the present invention.

The control unit 220 includes a synchronization unit 222, a strain deduction unit 224, and a compensation unit 226.

The synchronization unit 222 synchronizes measurement cycles of the plurality of sensors 20a to 20n. The synchronization unit 222 controls the sensors 20a to 20n to simultaneously measure a change in the external load of the structure 30 by synchronizing the measurement cycles of the sensors 20a to 20n.

The strain deduction unit 224 deducts a strain of the structure 30 by using vibration measured through the plurality of sensors 20a to 20n.

The strain deduction unit 224 curve-fits time-based variation of the strain value into a sine wave of a primary strain mode with respect to the structure 30, and calculates a maximum value and a minimum value of the strain. The primary strain mode includes a change in a low-frequency area having the highest energy level among changes of the structure with respect to the external load.

The structure monitoring apparatus 200 according to the second exemplary embodiment of the present invention excites the vibrating wire sensors 20a to 20n while changing a measurement frequency of the vibrating wire sensors 20a to 20n to thereby measure vibration signals of the vibrating wire sensors 20a to 20n. In addition, the structure monitoring apparatus 200 analyzes the measured vibration signal to calculate a resonance frequency of the vibrating wire sensors 20a to 20n, thereby calculating a strain value at the calculated resonance frequency.

The compensation unit 226 compensates the strain by using a change in the temperature measured by the measurement unit 210.

Hereinafter, a process for the structure monitoring apparatus 200 according to the second exemplary embodiment of the present invention to deduct the strain using the vibrating wire sensors and compensate the deducted strain will be described.

Each vibrating wire sensor 20 is fixed to the main member of the structure by welding or concrete-embedding opposite ends of a vibrating wire to the main member. In addition, the vibrating wire of the vibrating wire sensor undergoes tensile stress variation according to deformation of the structure or the main member, and thus a unique frequency (i.e., a resonance frequency) of the vibrating wire is changed.

Further, a relationship between a frequency (cycle) and deformation (strain) of the vibrating wire sensor 20 can be acquired as given in Equation 3 to Equation 8.

The resonance frequency of the vibrating wire can be acquired as given in Equation 3 using a function of a tensile force, a length, and a mass.

$$f = \frac{1}{2 {L}_{w}} \sqrt{F / m} \qquad [ Equation 3 ]$$

Here, Lw denotes a length of a vibrating wire of the vibrating wire sensor, F denotes a tensile force applied to the vibrating wire, and m denotes a mass of the vibrating wire per unit length.

The mass m per unit length of the vibrating wire can be acquired as given in Equation 4.

m=W/(L_{w}Sg)=(ρSa)/g [Equation 4]

Here, the mass m per unit length of the vibrating wire equals a total weight W of the vibrating wire, Lw denotes a total length of the vibrating wire, and g denotes acceleration due to gravity. In addition, p denotes a mass ratio, and a denotes a cross-sectional area of the vibrating wire.

The tensile force can be acquired as given in Equation 5.

F=εEa [Equation 5]

Here, ε denotes a strain and E denotes an elastic coefficient.

A relational expression between the strain and the frequency is expressed by Equation 6. The relational expression between the strain and the frequency can be derived by using Equation 4 and Equation 5.

$$ɛ = \frac{{ρ ( 2 {L}_{ω} f )}^{2}}{Eg} \qquad [ Equation 6 ]$$

As shown in Equation 7, a strain value due to temperature variation can be acquired according to a material to which the vibrating wire is installed.

ε=(T₁−T₂)K [Equation 7]

Here, T2 denotes a current temperature, T1 denotes a temperature at the time of sensor installation, and K denotes strain variation according to unit temperature variation and is determined according to a material to which the sensor is installed.

In addition, a final strain value can be deducted through Equation 8.

$$ɛ = \frac{{ρ ( 2 {L}_{ω} f )}^{2}}{Eg} + ( {T}_{1} - {T}_{2} ) K \qquad [ Equation 7 ]$$

The safety determination unit 230 calculates a stress with respect to the main member of the structure 30 using a maximum value and a minimum value of the strain, deducted by the strain deduction unit 224, and determines safety of the structure 30 based on the calculated stress.

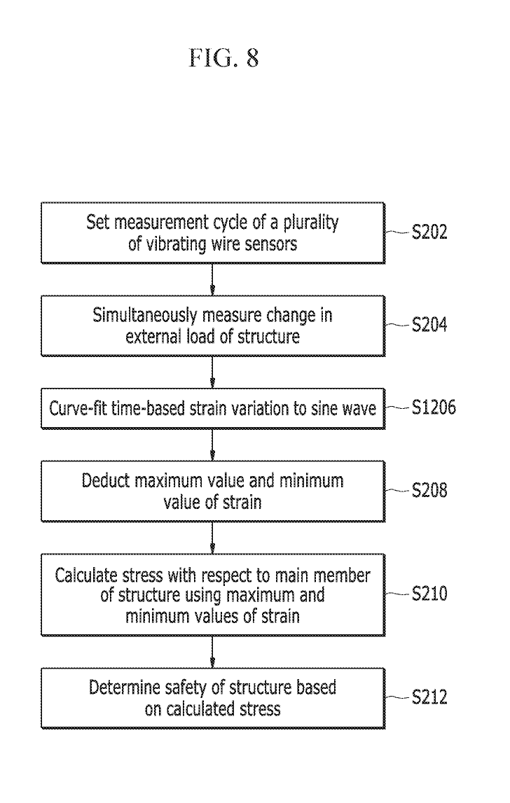

FIG. 8 is a schematic flowchart of a process for monitoring a structure by synchronizing measurement cycles of the vibrating wire sensors according to the second exemplary embodiment of the present invention. The following flowchart will be described in connection with the configuration of FIG. 7, and the same reference numerals of FIG. 7 will be used.

Referring to FIG. 8, the structure monitoring apparatus 200 according to the second exemplary embodiment of the present invention sets measurement cycles of the plurality of sensors 20a to 20n, and simultaneously measures a change in an external load of the structure 30 by using the plurality of sensors 20a to 20n (S202 and S204).

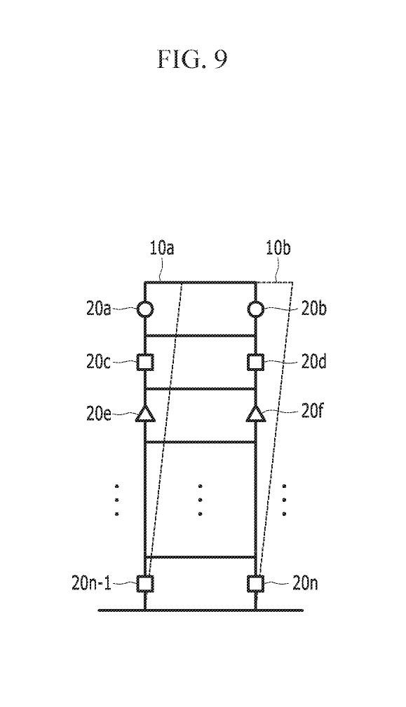

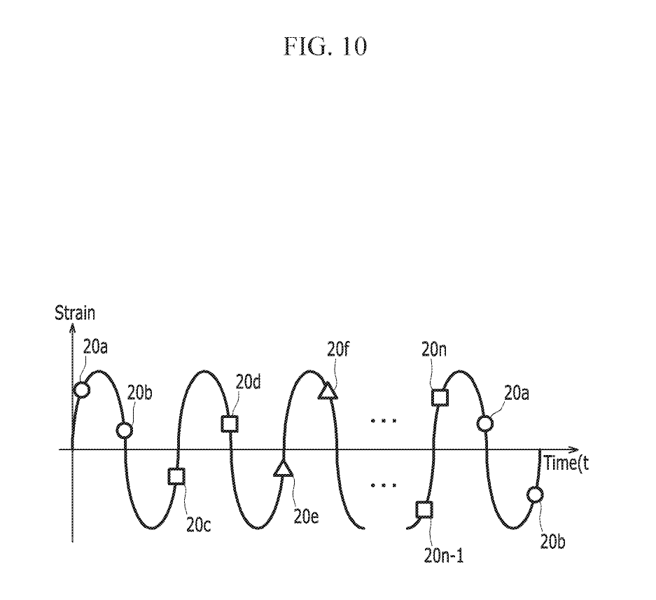

FIG. 9 exemplarily shows a layout of a plurality of vibrating wire sensors in a large-scaled structure, and FIG. 10 is a graph exemplarily illustrating sequential signal measurement of the sensors according to a conventional art.

Conventionally, strain of the vibrating wire sensor is measured through a complex process, and thus, in measurement of multi-channel vibrating wire sensors, a multiplex is generally used to sequentially measure signals of the respective sensors and calculate a resonance frequency.

Thus, conventionally, as shown in FIG. 10, it takes a long time to sequentially measure all the sensors 20a to 20b, and accordingly, safety determined through the measured signals may not be reliable.

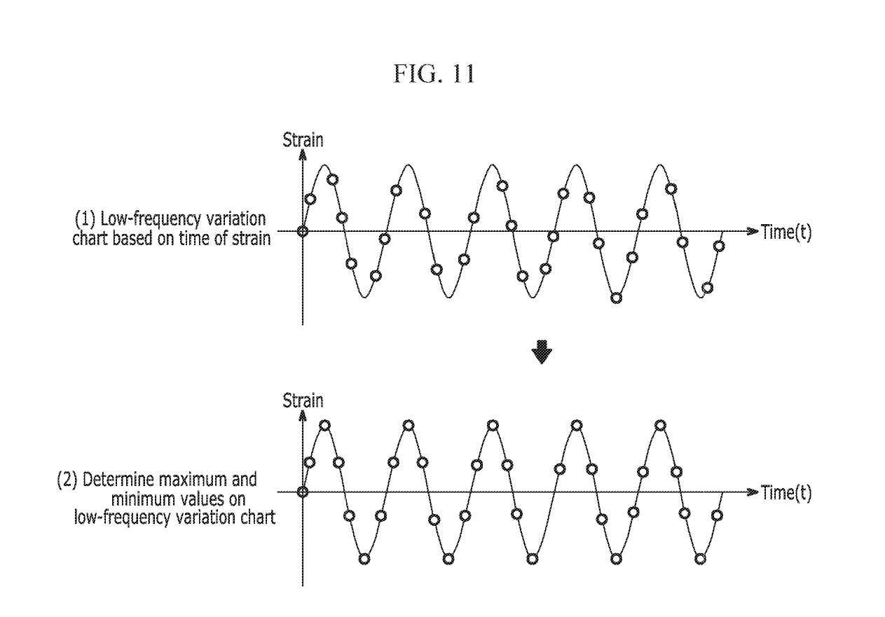

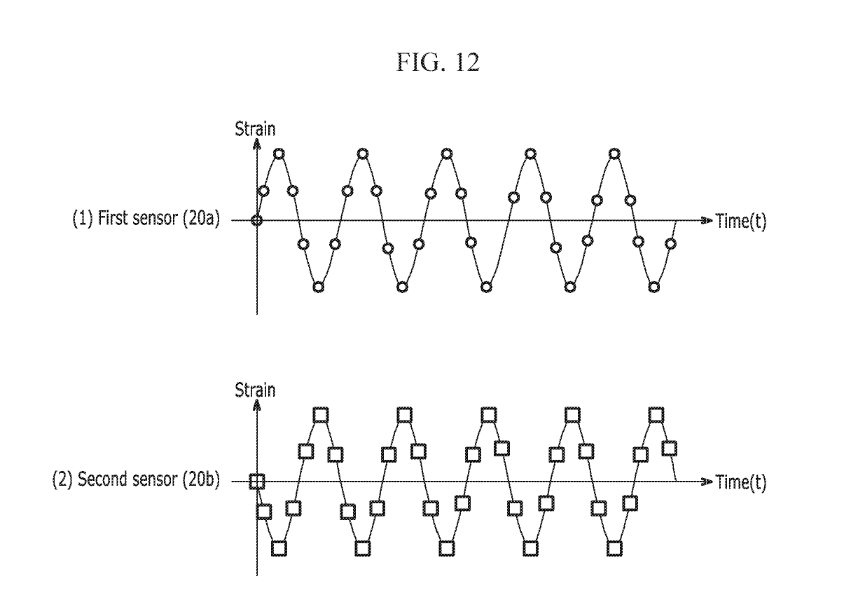

FIG. 11 is a graph exemplarily illustrating a low-frequency variation chart according to the second exemplary embodiment of the present invention, and FIG. 12 is a graph exemplarily illustrating deduction of maximum/minimum values of strain by forming a low frequency variation chart for each sensor according to the second exemplary embodiment of the present invention.

Referring to FIG. 11 and FIG. 12, the structure monitoring apparatus 200 according to the second exemplary embodiment of the present invention synchronizes measurement cycles of the plurality of sensors 20a to 20n and simultaneously measures the plurality of sensors 20a to 20n such that a large amount of data can be quickly acquired. In addition, the structure monitoring apparatus 200 according to the second exemplary embodiment of the present invention forms a chart of low-frequency variation based on time of strain by using signals acquired from the respective vibrating wire sensors 20a to 20n, and determines a maximum value and a minimum value on the low-frequency variation chart.

The structure monitoring apparatus 200 according to the second exemplary embodiment of the present invention performs measurement synchronization by simultaneously exciting the plurality of sensors 20a to 20n, measuring and storing synchronized vibration signals, and acquiring a resonance frequency by analyzing the respective vibration signals, and accordingly, a change of the strain due to measurement locations of sensors can be relatively predicted.

Accordingly, the structure monitoring apparatus 200 according to the second exemplary embodiment of the present invention can analyze an accurate strain mode so that a primary strain mode can be derived by curve-fitting.

The structure monitoring apparatus 200 according to the second exemplary embodiment of the present invention curve-fits the primary strain mode to a sine wave function through Equation 9.

$$f ( ω ) = {{Q}^{n}}_{i = 1} \vert g ( {t}_{i} ) - {y}_{i} \vert or \\ {{{Q}^{n}}_{i = 1} ( g ( {t}_{i} ) - {y}_{i} )}^{m} , {t}_{n} \frac{2 ω k}{ω} \qquad [ Equation 9 ]$$

Here, m denotes a multiple of 2, n denotes a number of measurement records of data, and yᵢ denotes i-th measurement values. In addition, g(tᵢ)=A sin (wtᵢ) is an i-th value of a sine wave function, and curve-fits measured data to a sine wave function. Further, k denotes a predetermined integer value, and indicates a data acquisition cycle.

The structure monitoring apparatus 200 curve-fits time-based strain variation to a sine wave, and deducts a maximum value and a minimum value of the strain (S206 and S208).

In addition, the structure monitoring apparatus 200 calculates a stress with respect to the main member of the structure using the maximum and minimum values of the strain, and determines safety of the structure using the calculated stress (S210 and S212).

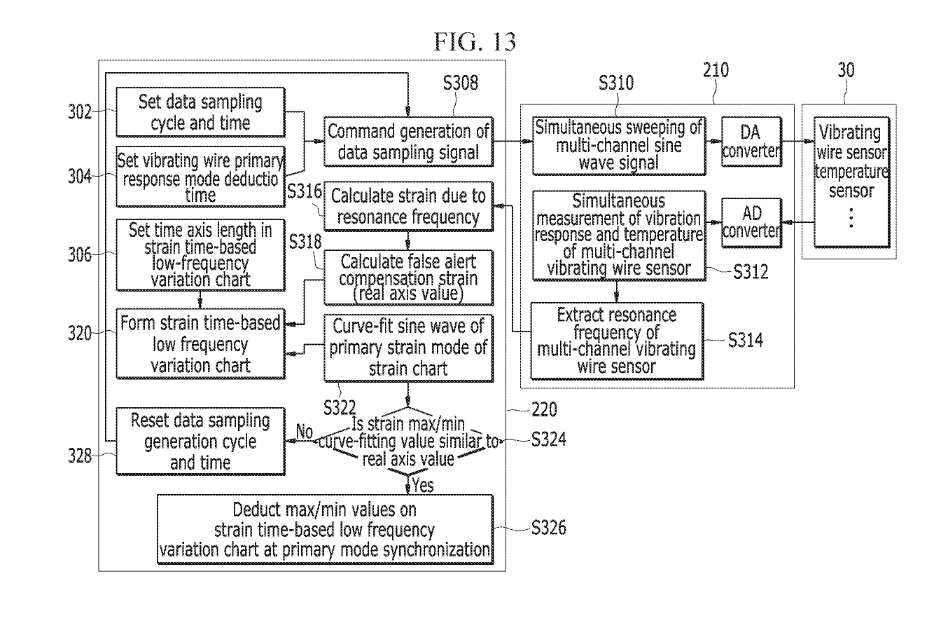

FIG. 13 shows a structure monitoring process according to the second exemplary embodiment of the present invention. The following flowchart will be described using the same reference numerals of FIG. 7.

Referring to FIG. 13, the structure monitoring apparatus 200 according to the second exemplary embodiment of the present invention controls the control unit 220 to set a data sampling cycle and deduction time of a primary response mode of the vibrating wire sensors, and commands the measurement unit 210 to generate a sampling signal (S302 to S308). Here, the primary response mode includes time taken for exciting the sensors and then acquiring data.

In addition, the structure monitoring apparatus 200 simultaneously sweeps sine wave signals from a low frequency to a high frequency to the plurality of vibrating wire sensors, and simultaneously measures vibration and temperatures from the plurality of vibrating wire sensors (S310 and S312).

The structure monitoring apparatus 200 extracts a resonance frequency of each vibrating wire sensor, calculates a strain due to the resonance frequency, and compensates the calculated strain by using a temperature value (S314 to S318).

Further, the structure monitoring apparatus 200 forms a low-frequency variation chart based on strain time, and deducts a maximum value and a minimum value of the strain by curve-fitting the low-frequency variation into a sine wave of a primary strain mode (S320 to S326). The primary strain mode includes a strain of the structure strain of the structure in a low frequency area among strains of the structure with respect to an external load.

In addition, the structure monitoring apparatus 200 resets a cycle and time of data sampling signal generation (S328). The structure monitoring apparatus 200 acquires a resonance frequency of the structure by using the sine wave function that performs curve-fitting, and resets a number of samples and a sampling start point to measure a maximum value and a minimum value of the frequency function, to thereby deduct a maximum value and a minimum value in the primary strain mode.

As described, the structure monitoring apparatus 200 according to the second exemplary embodiment of the present invention estimates maximum and minimum working strain generated from a low frequency dynamic behavior of the structure by synchronizing measurement of the multi-channel vibrating wire sensors, or measures the maximum and minimum working strain by adjusting sampling time for vibration measurement to thereby shorten measurement time in a large-scaled structure or a high-rise building and accurately monitor structural health.

Further, the structure monitoring apparatus according to the second exemplary embodiment of the present invention has vibrating wire sensors installed at locations where maximum stress sensitivity with respect to an external load is generated in a structure such as a building, automatically optimizes a measurement start point and a measurement cycle, and performs measurement synchronization of the vibrating wire sensors and curve-fitting with respect to the primary strain mode of the low frequency such that an environment where maximum strain occurrence time in time-based strain variation with respect to an external load applied to the building and the structure and strain at the time can be accurately measured and structural health can be more accurately monitored can be provided.

The above-described methods and apparatuses are not only realized by the exemplary embodiment of the present invention, but, on the contrary, are intended to be realized by a program for realizing functions corresponding to the configuration of the exemplary embodiment of the present invention or a recording medium for recording the program.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

1. A method for a large space structure collapse detection apparatus to detect collapse of a large space structure, comprising:
measuring a change in external load with respect to at least one main member in the large structure;
calculating a stress or stress sensitivity according to the measured change in the external load; and
comparing at least one of the calculated stress or the calculated stress sensitivity with a predetermined collapse diagnosis reference value and determining a risk of collapse of the large space structure.

2. The method for the large space structure collapse detection apparatus to detect collapse of the large space structure of claim 1, wherein the determination of the risk of collapse comprises determining that there is a risk of collapse of the large space structure when the stress or the stress sensitivity exceeds the collapse diagnosis reference value by a certain number of times or by a predetermined time period.

3. The method for the large space structure collapse detection apparatus to detect collapse of the large space structure of claim 2, further comprising:
storing the measured external load change and a result of the comparison between the stress or the stress sensitivity and the collapse diagnosis reference value; and
notifying the collapse risk to an external server when it is determined that the structure has a risk of collapse.

4. The method for the large space structure collapse detection apparatus to detect collapse of the large space structure of claim 1, wherein the external load comprises at least one of a snow load, a wind load, and an earthquake load.

5. The method for the large space structure collapse detection apparatus to detect collapse of the large space structure of claim 4, wherein the stress sensitivity comprises stress strain in the main member according to a change in the snow load, the wind load, or the earthquake load.

6. The method for the large space structure collapse detection apparatus to detect collapse of the large space structure of claim 1, wherein the at least one main member comprises a maximum occurrence location of the stress or the stress sensitivity with respect to the external load.

7. The method for the large space structure collapse detection apparatus to detect collapse of the large space structure of claim 6, wherein the maximum occurrence location of the stress or stress sensitivity comprises at least one of an upper end point of a roof material of the large space structure, a side point of the roof member, and a lower end point of a column member of the large space structure.

8. A large space structure collapse detection apparatus comprising:
a measurement unit that measures a change in external load with respect to at least one main member of a large space structure; and
a control unit that calculates stress or stress sensitivity according to the measured external load change, and determines a risk of collapse of the large space structure by comparing at least one of the stress or the stress sensitivity with a predetermined collapse diagnosis reference value.

9. The large space structure collapse detection apparatus of claim 8, wherein the measurement unit measures the external load change from sensors that are disposed in maximum occurrence locations of the stress or the stress sensitivity with respect to the external load.

10. The large space structure collapse detection apparatus of claim 9, wherein the maximum stress or maximum stress sensitivity occurrence locations comprise a location having the highest stress or stress strain in the main member according to a change in one of external loads of a snow load, a wind load, and an earthquake load.

11. The large space structure collapse detection apparatus of claim 10, wherein the control unit comprises:
a sensitivity calculation unit that calculates stress and stress sensitivity according to the measured external load change; and
a collapse risk determination unit that determines a collapse risk of the large space structure by comparing the calculated stress and the calculated stress sensitivity with a predetermined collapse diagnosis reference value.

12. The large space structure collapse detection apparatus of claim 11, wherein the sensitivity calculation unit calculates stress strain of the main member according to a change in the snow load, the wind load, or the earthquake load at the maximum stress occurrence location or the maximum stress sensitivity occurrence location.

13. The large space structure collapse detection apparatus of claim 12, further comprising:
a database that stores the measured external load change and a result of comparison between the stress and stress sensitivity and the collapse diagnosis reference value; and
a collapse risk notification unit that notifies a collapse risk to an external server when it is determined that the large space structure has a collapse risk.

14. A method for a structure monitoring apparatus to monitor safety of a structure by measuring vibration of the structure, comprising:
setting measurement cycles of a plurality of sensors disposed in the structure;
simultaneously measuring a change in external load of the structure using at least two of the plurality of sensors according to the predetermined measurement cycles; and
calculating strain of the structure by simultaneously analyzing measured signals and forming a time-based strain variation chart.

15. The method for the structure monitoring apparatus to monitor safety of the structure by measuring vibration of the structure of claim 14, wherein the forming of the strain variation chart comprises deducting maximum and minimum strain values by curve-fitting time-based strain values to a sine wave.

16. The method for the structure monitoring apparatus to monitor safety of the structure by measuring vibration of the structure of claim 15, further comprising calculating a stress with respect to a main member of the structure by using the maximum and minimum strain values, and determining safety of the structure by using the calculated stress.

17. The method for the structure monitoring apparatus to monitor safety of the structure by measuring vibration of the structure of claim 16, wherein the setting of the measurement cycle comprises synchronization of measurements of the plurality of sensors.

18. The method for the structure monitoring apparatus to monitor safety of the structure by measuring vibration of the structure of claim 16, wherein the plurality of sensors comprise vibrating wire sensors.

19. The method for the structure monitoring apparatus to monitor safety of the structure by measuring vibration of the structure of claim 18, wherein the measuring comprises exciting the vibrating wire sensors while changing measurement frequencies of the vibrating wire sensors and measuring vibration signals of the vibrating wire sensor, and
the forming of the strain variation chart comprises:
calculating resonance frequencies of the vibrating wire sensors by analyzing the measured vibration signals; and
calculating strain values in the resonance frequencies.

20. The method for the structure monitoring apparatus to monitor safety of the structure by measuring vibration of the structure of claim 19, wherein the measuring further comprises simultaneous measuring of temperatures of the vibrating wire sensors together with the vibration signals of the vibrating wire sensors, and
the deducting of the strain further comprises compensating the calculated strain by using variation of the measured temperature.

21-29. (canceled)
